(19) United States
(12) Patent Application Publication
(10) Pub. No.: US 2017/0129521 A1
(43) Pub. Date: May 11, 2017

(54) GERMSEAL SHOPPING CART LINERS

(71) Applicants: Jennifer Conroy, Phoenix, AZ (US); Tamara Jamison, Surprise, AZ (US)

(72) Inventors: Jennifer Conroy, Phoenix, AZ (US); Tamara Jamison, Surprise, AZ (US)

(21) Appl. No.: 15/280,409

(22) Filed: Sep. 29, 2016

Related U.S. Application Data
(60) Provisional application No. 62/251,269, filed on Nov. 5, 2015.

(51) Int. Cl. B62B 3/14; B62B 5/06; B62B 3/02

(52) U.S. Cl. CPC B62B 3/1436; B62B 3/02; B62B 3/1464; B62B 5/069; B62B 3/1448

(57) ABSTRACT

A dual purpose liner for a shopping cart is a liner that is designed to be placed within a shopping cart to cover the contact surfaces to prevent the transference of pathogens to users of the cart.

### CROSS REFERENCE TO RELATED APPLICATION

The present application includes subject matter related, and claims priority, to a provisional application entitled “GERMSEAL CART COVERS” filed Nov. 5, 2015 and assigned Ser. No. 62/251,269 describing an invention made by the present inventors.

### FIELD OF THE INVENTION

The present invention relates generally to the field of protective covers for shopping carts and more specifically relates to a dual purpose liner for a shopping cart.

### DESCRIPTION OF THE RELATED ART

This last century has seen much advancement in technology. One of the advancements is that of transportation. With transportation now being readily available to most anyone in the general public, travel has become commonplace between countries. Along with the advancements, there are unintended negative effects. For one, the spreading of strange diseases to countries that are ill equipped to deal with them has become a problem. As an example, there have been several cases of flesh eating bacteria contracted now within this country. Some pathogens are airborne and others are waterborne. Yet others can be contracted merely from the contact of contaminated dry surfaces. The most likely surfaces to carry germs are those surfaces contacted frequently by the general public.

Most people are aware of the dangers of contacting surfaces within public restrooms, yet there are other surfaces that get contacted even more frequently by the public that are generally not thought of as disease carrying surfaces. Shopping carts are handled all day long by numerous people and are seldom if ever disinfected. As a result, some of these potential disease carrying surfaces may carry any kind of pathogen that could originate from another country, that until recently was only read about or seen on television in this country. The interior surfaces of shopping carts come in direct contact with unpackaged groceries that could ultimately be the source for infection. Even more at peril are children when their parents place them in the upper portion of the shopping cart. That portion of the cart is most frequently handled by the general public, and small children are most vulnerable to pathogens that may have been deposited on those surfaces because of their under-developed immune systems. Disinfecting hand gels clean hands after the fact, but are less practical for very small children. A convenient solution is needed that would prevent contact with germs in the first place, and provide peace of mind for the user.

Shopping carts are used in stores to allow user/customers to push around a wheels cart to add items for purchase. These carts are often reused and can be come soiled or dirty. A cover that allows sanitary usage and avoids soiling of items or people stored therein.

Various attempts have been made to solve the above-mentioned problems such as those found in U.S. Pat. No. 7,374,182 to Connie Gurley, U.S. Pat No. 4,805,937 to Joan L. Boucher; and U.S. Pat. No. 6,517,155 to Marc Landine. This art is representative of shopping cart covers. None of the above inventions and patents, taken either singly or in combination, is seen to describe the invention as claimed.

Ideally, a shopping cart cover should provide convenience of use and be multi-functional, and yet, would provide reliability and be manufactured at a modest expense. Thus, a need exists for a reliable dual purpose liner for a shopping cart to avoid the above-mentioned problems.

### BRIEF SUMMARY OF THE INVENTION

In view of the foregoing disadvantages inherent in the known shopping cart cover art, the present invention provides a novel dual purpose liner for a shopping cart. The general purpose of the present invention, which will be described subsequently in greater detail, is to provide a barrier against contacting contaminated surfaces of a shopping cart while having alternative uses when not being used in a shopping cart.

The dual purpose liner for a shopping cart preferably comprises a liner body that includes front and back walls, two opposite side walls, and a bottom portion that together, when placed in a shopping cart, form a liner having an interior volume for placing items to be purchased therein, and having an exterior surface for contacting the inner surface of a shopping cart that functions as a barrier to protect the user against germs. A shopping cart handle cover may attach to the upper end of the back wall of the liner body and is adapted to cover the shopping cart handle to provide a barrier against contact with germs on the highest contact surface of the cart. In a preferred embodiment, the handle cover is preferably formed integrally with the liner body but may be separate but attachable to the remainder of the liner body.

A top basket divider cover is adapted to cover the folding wall of the top basket of a shopping cart and may be designed to be removable from the liner body attachable via hook and loop fasteners, but in the preferred embodiment, the top basket wall cover may be non-removable from the liner body. As a second function, the liner body is designed to be folded to function as a purse. An adjustable carrying strap is adapted for dual use so that it can be used as a carrying strap when the liner body is folded as a purse or carry bag, and as a child seatbelt when a child is seated in the top basket of the shopping cart. A hook and loop fastener is adapted to secure the liner body to the shopping cart when the shopping cart is in an in-use condition, or may be used as a means to secure the liner in place when folded to function as a purse. There is at least one leg opening in the back wall of the liner body in the child seating area of the top basket for inserting the legs of a child through when a child is seated in the top basket.

The liner body is designed to be placed within a shopping cart to cover all of the contact surfaces of the shopping cart to prevent the transference of pathogens to a user of the shopping cart or to a child seated in the top basket of the cart. The liner body is also designed to overlap the top edge of the shopping cart on all 4 sides to prevent accidental contact with the top edges of the cart. The liner body has a hook and loop fastener adapted for securing the liner body in place when it is folded inward to function as a purse and is adapted to secure the liner body within the shopping cart when used as a shopping cart liner. The liner body is preferably designed to be used universally with different dimensions of shopping carts so that one shopping cart liner may be used for all types of carts in all shopping locations.

The liner body preferably comprises 3 sections of shaped fabric attached together to form a germ barrier. The 3 individual sections form a zippered pouch, a top basket divider cover, and a liner body that when attached together as designed, form an effective liner body. In other embodiments, the liner body may comprise more than 3 shaped sections. The liner body further is constructed out of an impermeable the fabric, but yet is washable after use so that it can be used multiple times to provide a long life span. The liner body further comprises a zippered pouch for securing items therein when used either as a shopping cart liner or as a purse. The zippered pouch is preferably attachable via the hook and loop fasteners to the liner body and located exteriorly when the liner body is folded to function as the purse and located in a convenient location when used as a cart liner for placing personal items therein.

The dual purpose liner for a shopping cart may be sold as a kit that includes a fully assembled body liner having a zippered pouch, a top basket divider cover, a liner body, and at least one set of user instructions.

A method for using the dual purpose liner for a shopping cart may comprise the steps of unfolding the liner body, placing the liner body within a shopping cart, securing the liner body to the shopping cart via at least one hook and loop fastener, placing the top basket divider cover over the top basket divider and attaching it to the liner body, using the liner body for shopping, folding the liner body into a purse, and attaching the zippered pocket to the folded liner body.

The present invention holds significant improvements and serves as a dual purpose liner for a shopping cart. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, dual purpose liner for a shopping cart, constructed and operative according to the teachings of the present invention.

FIG. 1 shows a perspective view illustrating an in-use condition of a dual purpose liner for a shopping cart according to an embodiment of the present invention.

FIG. 2 is a perspective view illustrating an installed dual purpose liner for the shopping cart according to an embodiment of the present invention of FIG. 1.

FIG. 3 is a side elevation view illustrating the dual purpose liner for the shopping cart according to an embodiment of the present invention of FIG. 1.

FIG. 4 is a diagram illustrating a pattern for the dual purpose liner for the shopping cart according to an embodiment of the present invention of FIG. 1.

FIG. 5 is a flowchart illustrating a method of use for the dual purpose liner for a shopping cart according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a shopping cart cover and more particularly to a dual purpose liner for a shopping cart as used to prevent contact with contaminated surfaces of a shopping cart while having alternative uses.

Generally speaking, dual purpose liner for a shopping cart is a liner that is designed to be placed within a shopping cart to cover the contact surfaces to prevent the transference of pathogens to users of the cart.

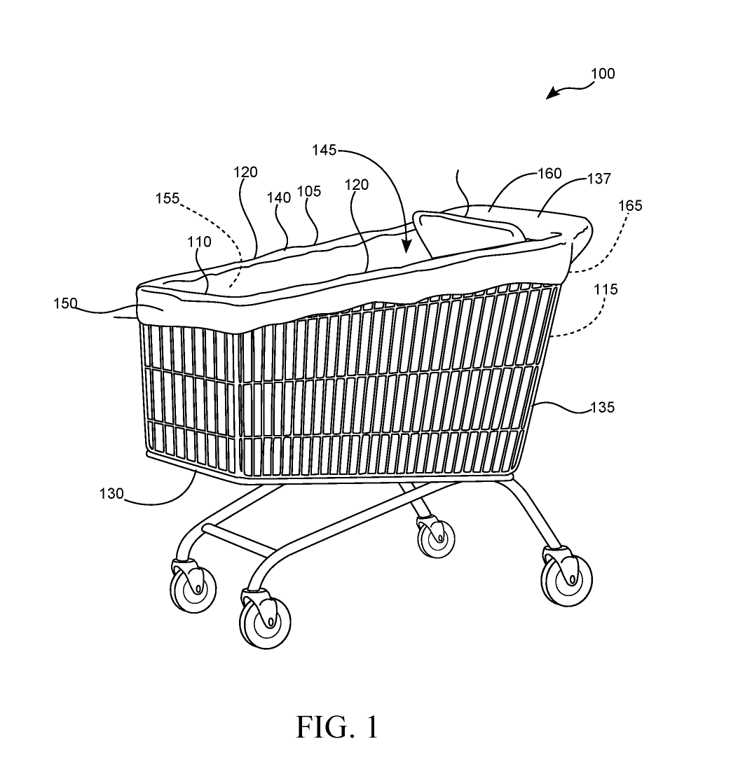

Referring to the drawings by numerals of reference there is shown in FIG. 1, a perspective view illustrating an in-use condition of dual purpose liner for a shopping cart 100 according to an embodiment of the present invention.

Dual purpose liner for a shopping cart 100 preferably comprises liner body 105 that includes front 110 and back walls 115, two opposite side walls 120, and bottom portion 130 that together, when placed in shopping cart 135, form liner 140 having interior volume 145 for placing items to be purchased therein, and having exterior surface 150 for contacting inner surface 155 of shopping cart 135 that functions as a barrier to protect the user against germs. Shopping cart handle cover 160 may attach to upper end 165 of back wall 115 of liner body 105 and is adapted to cover shopping cart handle 137 to provide a barrier against contact with germs on the highest contact surface of shopping cart 135. In a preferred embodiment, shopping cart handle cover 160 is preferably formed integrally with liner body 105 but may be separate but attachable to the remainder of liner body 105.

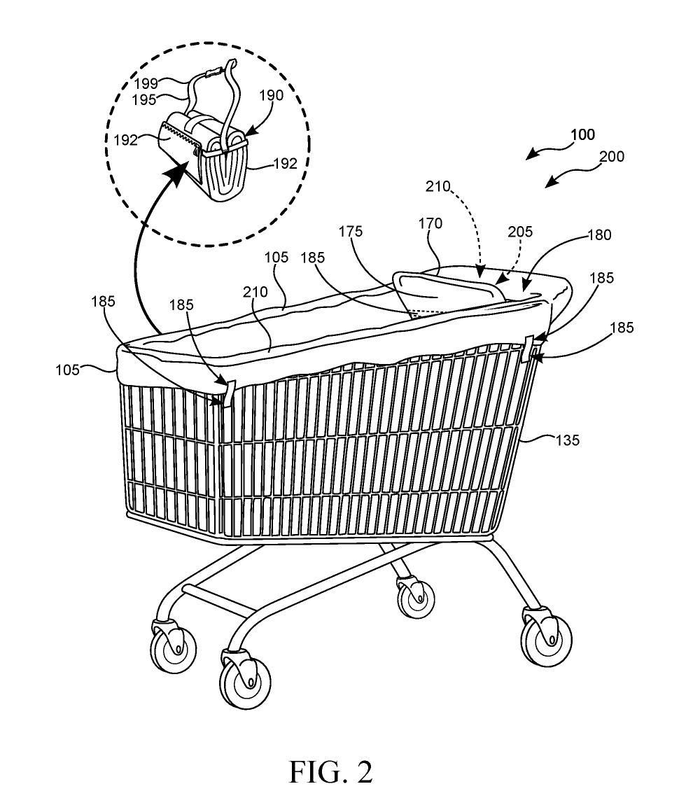

Referring now to FIG. 2, a perspective view illustrating an installed dual purpose liner for a shopping cart 100 according to an embodiment of the present invention of FIG. 1.

Top basket divider cover 170 is adapted to cover folding wall 175 of top basket 180 of shopping cart 135 and may be designed to be removable from liner body 105 attachable via hook and loop fasteners 185, but in the preferred embodiment, top basket divider cover 170 may be non-removable from liner body 105. As a second function, liner body 105 is designed to be folded and to function as purse 190 as shown in the call-out in FIG. 2. Adjustable carrying strap 195 is adapted for dual use so that it can be used as adjustable carrying strap 195 when liner body 105 is folded as purse 190 or carry bag 192, and as child seatbelt 199 when a child is seated in top basket 180 of shopping cart 135. Hook and loop fastener 185 is adapted to secure liner body 105 to shopping cart 135 when shopping cart 135 is in in-use condition 200, or may be used as a means to secure liner body 105 in place when folded to function as purse 190. There is at least one leg opening 205 in back wall 115 of liner body 105 in child seating area 210 of top basket 180 for inserting the legs of a child through when a child is seated in top basket 180.

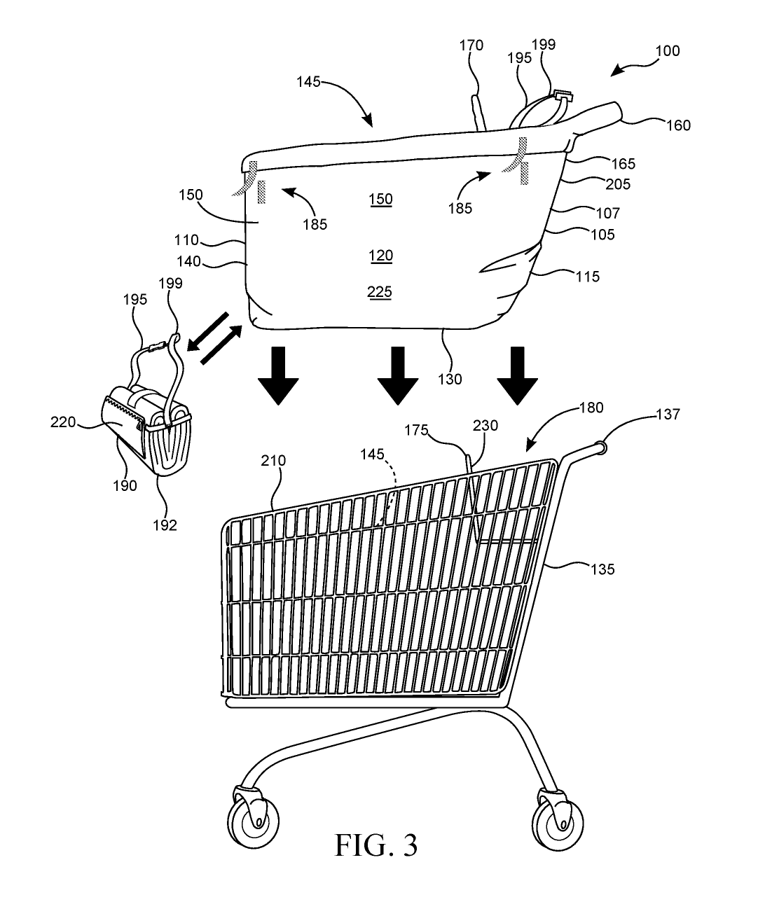

Referring now to FIG. 3, a side elevation view illustrating dual purpose liner for a shopping cart 100 according to an embodiment of the present invention of FIG. 1.

Liner body 105 is designed to be placed within shopping cart 135 to cover all of the contact surfaces of shopping cart 135 to prevent the transference of pathogens to a user of shopping cart 135 or to a child seated in top basket 180 of shopping cart 135. Liner body 105 is also designed to overlap top edge 210 of shopping cart 135 on all 4 sides to prevent accidental contact with top edge(s) 210 of shopping cart 135. Liner body 105 has hook and loop fasteners 185 adapted for securing liner body 105 in place when it is folded inward to function as purse 190 and is adapted to secure liner body 105 within shopping cart handle 137 when used as shopping cart liner 107. Liner body 105 is preferably designed to be used universally with different dimensions of shopping cart(s) 135 so that one shopping cart liner 107 may be used for all types of shopping cart(s) 135 in all shopping locations.

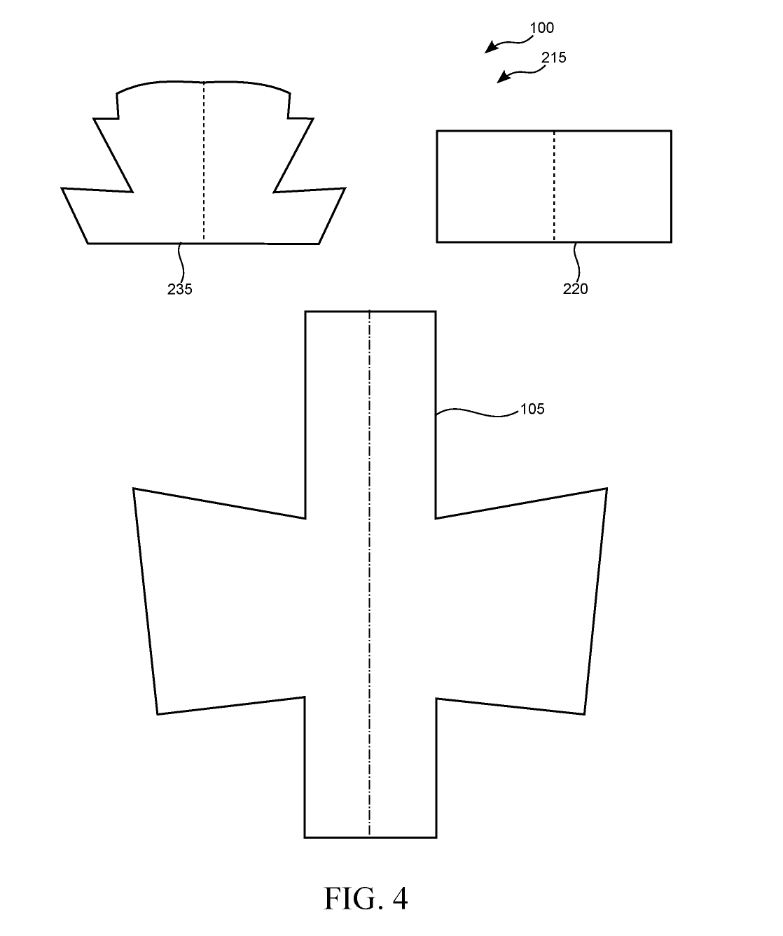

Referring now to FIG. 4, showing a diagram illustrating a pattern for dual purpose liner for a shopping cart 100 according to an embodiment of the present invention of FIG. 1.

Liner body 105 preferably comprises 3 sections of shaped fabric 215 attached together to form a germ barrier. The 3 individual sections form zippered pouch 220, top basket divider cover 170, and liner body 105 that when attached together as designed, form an effective liner body 105. In other embodiments, liner body 105 may comprise more than 3 shaped fabric 215 section(s). Liner body 105 further is constructed out of impermeable fabric 225, but yet is washable after use so that it can be used multi* times to provide a long life span. Liner body 105 further comprises zippered pouch 220 for securing items therein when used either as shopping cart liner 107 or as purse 190. Zippered pouch 220 is preferably attachable via hook and loop fasteners 185 to liner body 105 and located exteriorly when liner body 105 is folded to function as purse 190 and located in a convenient location when used as shopping cart liner 107 for placing personal items therein.

Dual purpose liner for a shopping cart 100 may be sold as kit 450 comprising the following parts: at least one fully assembled liner body 105 having zippered pouch 220, top basket divider cover 170, liner body 105, and at least one set of user instructions. The kit has instructions such that functional relationships are detailed in relation to the structure of the invention (such that the invention can be used, maintained, or the like in a preferred manner). dual purpose liner for a shopping cart 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

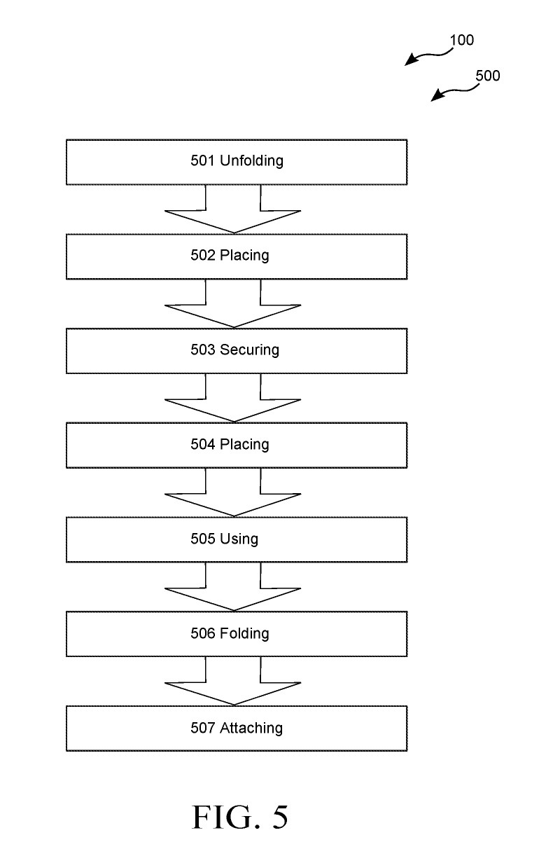

Referring now to FIG. 5, showing method of use 500 for dual purpose liner for a shopping cart 100. A method of using dual purpose liner for a shopping cart 100 may comprise the steps of step one 501 unfolding liner body 105; step two 502 placing liner body 105 within shopping cart(s) 135; step three 503 securing liner body 105 to shopping cart(s) 135 via at least one hook and loop fastener(s) 185; step four 504 placing top basket divider cover 170 over top basket divider 230 and attaching it to liner body 105; step five 505 using liner body 105 for shopping; step six 506 folding liner body 105 into purse 190; and step seven 507 attaching zippered pouch 220 to the folded liner body 105.

It should be noted that steps 503 and 504 are optional steps and may not be implemented in all cases. Optional steps of method 500 are illustrated using dotted lines in FIG. 5 so as to distinguish them from the other steps of method 500.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A dual purpose liner for a shopping cart comprising:
a liner body including a front wall and a back wall, two opposite side walls, and a bottom portion forming an interior volume for placing items to be purchased therein and an exterior surface for contacting an inner surface of said shopping cart;
a shopping cart handle cover attached to an upper end of said back wall of said liner body adapted to cover a shopping cart handle;
a top basket divider cover adapted to cover a folding wall of a top basket of a shopping cart;
an adjustable carrying strap adapted for dual use as a carrying strap and as a child seatbelt when a child is seated in said top basket of said shopping cart;
a hook and loop strip to secure said liner body to said shopping cart during an in-use condition;
at least one leg opening in said liner body at a child seating area of said top basket for inserting the legs of said child therethrough; and
wherein said liner body is structured and arranged to be placed within a shopping cart to cover all contact surfaces of said shopping cart to prevent a transference of pathogens from a surface of the shopping cart to a user.

2. The dual purpose liner for a shopping cart of claim 1 wherein said liner body further comprises an impermeable fabric.

3. The dual purpose liner for a shopping cart of claim 2 wherein said liner body is structured and arranged to be folded to function as a purse.

4. The dual purpose liner for a shopping cart of claim 3 wherein said liner body further comprises a zippered pouch for securing items therein.

5. The dual purpose liner for a shopping cart of claim 2 wherein said fabric of said liner body is washable.

6. The dual purpose liner for a shopping cart of claim 2 wherein said liner body is re-useable.

7. The dual purpose liner for a shopping cart of claim 1 wherein said liner body is disposable.

8. The dual purpose liner for a shopping cart of claim 1 wherein said liner body is designed to overlap a top edge of a shopping cart on 4 sides.

9. The dual purpose liner for a shopping cart of claim 1 wherein said top basket wall cover is removable from said liner body.

10. The dual purpose liner for a shopping cart of claim 1 wherein said top basket wall cover is integrally formed with said liner body and is non-removable.

11. The dual purpose liner for a shopping cart of claim 1 wherein said liner body further comprises a hook and loop fastener adapted for securing said liner body in place when folded.

12. The dual purpose liner for a shopping cart of claim 1 wherein said liner body comprises at least three sections of shaped fabric attached together to form a barrier.

13. The dual purpose liner for a shopping cart of claim 11 wherein said hook and loop fastener is adapted to secure said liner body in place within said shopping cart.

14. The dual purpose liner for a shopping cart of claim 1 wherein said top basket wall cover is non-removable from said liner body.

15. The dual purpose liner for a shopping cart of claim 4 wherein said zippered pouch is located exteriorly when said liner body is folded into a purse.

16. The dual purpose liner for a shopping cart of claim 15 wherein said zippered pouch is attachable via hook and loop fasteners to said liner body.

17. The dual purpose liner for a shopping cart of claim 1 wherein said liner body is able to be used universally with different sizes and shapes of shopping carts.

18. A dual purpose liner for a shopping cart comprising:
a liner body including a front wall and a back wall, two opposite side walls, and a bottom portion forming an interior volume for placing items to be purchased therein, and an exterior surface for contacting an inner surface of said shopping cart;
a shopping cart handle cover attached to an upper end of said back wall of said liner body adapted to cover a shopping cart handle;
a top basket divider cover adapted to cover a folding wall of a top basket of a shopping cart;
an adjustable carrying strap adapted for dual use as a carrying strap and as a child seatbelt when a child is seated in said top basket of said shopping cart;
a hook and loop fastener to secure said liner body to said shopping cart during an in-use condition;
at least one leg opening in said liner body at a child seating area of said top basket for inserting the legs of said child therethrough;
wherein said liner body is structured and arranged to be placed within said shopping cart to cover all contact surfaces of said shopping cart to prevent a transference of pathogens to a user;
wherein said liner body is designed to overlap a top edge of said shopping cart on four sides;
wherein said liner body further comprises a hook and loop fastener adapted for securing said liner body in place when folded;
wherein said hook and loop fastener is adapted to secure said liner body within said shopping cart;
wherein said liner body is able to be used universally with different dimensions of said shopping carts;
wherein said liner body comprises at least three sections of shaped fabric attached together to form a barrier;
wherein said at least three sections comprise said zippered pouch, said top basket divider cover, of said liner body;
wherein said liner body further comprises an impermeable fabric;
wherein said fabric of said liner body is washable;
wherein said liner body is reuseable;
wherein said top basket wall cover is removable from said liner body;
wherein said liner body is structured and arranged to be folded to function as a purse;
wherein said liner body further comprises said hook and loop fastener adapted for securing said liner body in place when folded;
wherein said liner body further comprises a zippered pouch for securing items therein;
wherein said zippered pouch is attachable via said hook and loop fasteners to said liner body; and
wherein said zippered pouch is located exteriorly when said liner body is folded to function as said purse.

19. The dual purpose liner for a shopping cart of claim 18 further comprising a kit including:
a fully assembled and attached body liner comprising said zippered pouch,
said top basket divider cover, and said liner body; and
at least one set of user instructions.

20. A method of using a dual purpose liner for a shopping cart comprising the steps of:
unfolding a liner body;
placing said liner body within a shopping cart;
securing said liner body to said shopping cart via at least one hook and loop fastener;
attaching a top basket divider cover over a top basket divider and attaching to said liner body;
using said liner body for shopping;
folding said liner body into a purse; and
attaching said zippered pocket to said folded liner body.
